(19) United States
(12) Patent Application Publication
(10) Pub. No.: US 2011/0267365 A1
(43) Pub. Date: Nov. 3, 2011

(54) METHODS AND SYSTEMS FOR CORRECTING THE APPEARANCE OF IMAGES DISPLAYED ON AN ELECTRONIC VISUAL DISPLAY

(75) Inventors: Hubert Kostal, Kirkland, WA (US); Ronald F. Rykowski, Bellevue, WA (US)

(73) Assignee: Radiant Imaging, Inc.

(21) Appl. No.: 12/772,916

(22) Filed: May 3, 2010

(51) Int. Cl. G09G 5/02; H04N 7/18

(52) U.S. Cl. 345/595; 348/129; 348/E07.085

(57) ABSTRACT

The present disclosure is directed to methods, systems, and apparatuses for correcting or modifying images to be shown on a visual display sign or display. A method in accordance with one embodiment includes determining an actual display value for one or more portions of the sign, and comparing the actual display value with a target display value for the one or more portions of the sign. The method further includes determining a correction factor for the one or more portions of the sign, and processing or adjusting the image with the correction factors for the corresponding portions of the sign. After processing the image, the method can further include transmitting the image to the display and showing the image on the display according to the target display value of the one or more portions without modifying the actual display value of the one or more portions.

### TECHNICAL FIELD

The present disclosure relates generally to methods and systems for displaying images on electronic visual displays, and more particularly, to processing or correcting images to be displayed on such displays.

### BACKGROUND

Signs are frequently used for displaying information to viewers. Such signs include, for example, billboards or other types of large outdoor displays, including electronic visual displays. Electronic visual displays or signs are typically very large, often measuring several hundred square feet in size. Electronic signs or displays have become a common form of advertising. For example, such displays are frequently found in sports stadiums, arenas, public forums, and/or other public venues for advertising diverse types of information. These displays are often designed to catch a viewer's attention and create a memorable impression very quickly.

### BRIEF DESCRIPTION OF THE DRAWINGS

FIG. 1 is a schematic view of an image processing system configured in accordance with an embodiment of the disclosure.

FIG. 2 is a schematic block diagram of the image processing system of FIG. 1.

FIG. 3 is an enlarged partial front view of a portion of a visual display sign configured to be used with embodiments of the disclosure.

FIG. 4 is a flow diagram of a method or process configured in accordance with an embodiment of the disclosure.

### DETAILED DESCRIPTION

### A. Overview

The following disclosure describes image processing systems and associated methods for processing images to be shown on visual display signs, such as large electronic visual displays. As described in greater detail below, an image processing method and/or system configured in accordance with one aspect of the disclosure is configured to process or modify an image to account for variations in an electronic display sign. The processed image, rather than the electronic sign, contains any correction or calibration information necessary to display the image on the electronic sign according to a desired or target appearance. Since the image itself contains any correction or calibration information, there is no need to calibrate or otherwise adjust the sign. There is also no need for the sign to have built-in correction capability or to use specialized video processing equipment to perform the correction.

For example, a method in accordance with one embodiment of the disclosure for processing an image to be shown on a sign includes determining an actual display value for one or more portions of the sign. In certain embodiments the image can be a static image. In other embodiments, however, the image can be a video stream comprised of a series of images. In certain embodiments, the actual display value can be a measured color value or luminance value of the one or more portions of the display. The method further includes comparing the actual display value with a desired display value for the one or more portions of the sign, and determining a correction factor for the one or more portions of the sign. The correction factor can be based at least in part on the comparison between the actual display values and the desired display values. The method further includes processing or adjusting the image with the correction factors for the corresponding portions of the sign. After processing the image to account for variations in the sign, the method can further include transmitting the image to the sign and showing the image on the sign. Accordingly, and as described in detail below, the image can be shown on the sign according to the desired display values without modifying or calibrating the actual display values of the corresponding portions of the sign, even though the sign is not performing any image correction.

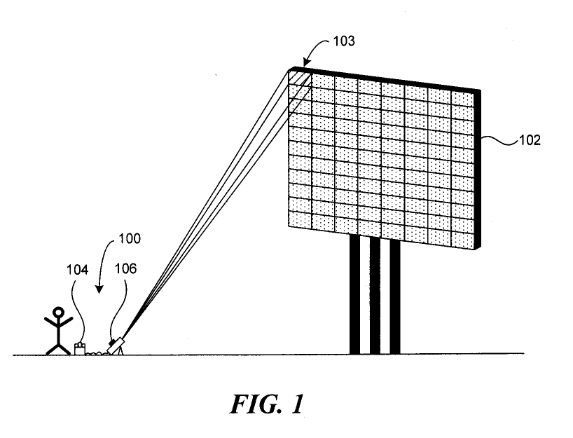

Certain details are set forth in the following description and in FIGS. 1-4 to provide a thorough understanding of various embodiments of the disclosure. However, other details describing well-known structures and systems often associated with visual displays and related optical equipment and/or other aspects of visual display calibration systems are not set forth below to avoid unnecessarily obscuring the description of various embodiments of the disclosure.

Many of the details, dimensions, angles, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

### B. Embodiments of Image Processing Systems and Associated Methods for Processing Images to be Shown on Electronic Visual Display Signs

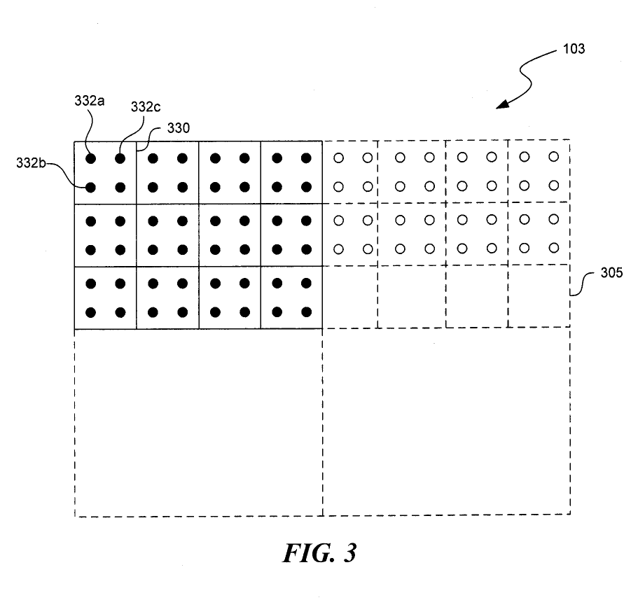

FIG. 1 is a schematic view of an image processing system 100 (“the system 100”) configured in accordance with one embodiment of the disclosure. The system 100 is configured to collect, manage, and/or analyze display data for the purpose of processing images (e.g., static images, video streams comprised of a series of images, etc.) that will be shown on an electronic visual display or sign 102. The sign 102, for example, can be a large electronic display or sign for showing static images. As discussed in detail below, embodiments of the present disclosure are directed to use with electronic signs that have measurable display properties or characteristics corresponding to individual imaging areas of the signs. Further details of the sign 102 illustrated in FIG. 1 are described below with reference to FIG. 3.

In the embodiment illustrated in FIG. 1, the system 100 includes a computing device 104 operably coupled to an imaging device 106 (e.g., an imaging photometer). The imaging device 106 is spaced apart from the sign 102 and configured to sense or capture display information (e.g., color data, luminance data, etc.) from one or more portions of the sign 102. For example, the imaging device 106 can capture display information from an imaging area 103 of the sign 102. The imaging area 103 is described in detail below with reference to FIG. 3. The captured display information is transferred from the imaging device 106 to the computing device 104. After capturing or otherwise sensing the display information for one imaging area 103, the imaging device 106 can be repositioned to capture more display information from other portions or imaging areas 103 of the sign 102. This process can be repeated until the computing device 104 obtains display information for the entire sign 102. The computing device 104 is configured to store, manage, and/or analyze the display information from each imaging area 103 to determine one or more correction factors for portions of the imaging area 103.

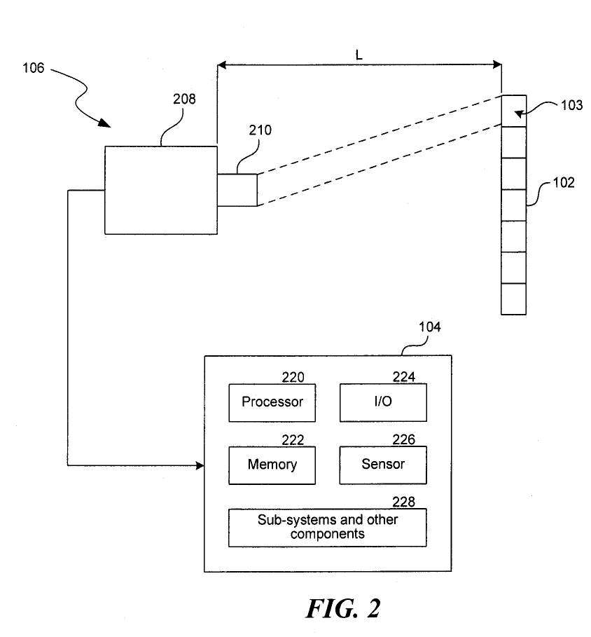

One of ordinary skill in the art will understand that although the system 100 illustrated in FIG. 1 includes two separate components, in other embodiments the system 100 can incorporate more or less than two components. Moreover, the various components can be further divided into subcomponents, or the various components and functions may be combined and integrated. In addition, these components can communicate via wired or wireless communication, as well as by information contained in storage media. A detailed discussion of the various components and features of the image processing system 100 is described below with reference to FIG. 2.

FIG. 2 is a schematic block diagram of one embodiment of the system 100 described above with reference to FIG. 1. In the illustrated embodiment, the imaging device 106 can include a camera 208, such as a digital camera suitable for high-resolution long-distance imaging. For example, the camera 208 can include optics capable of measuring subpixels of the sign 102 (which can be a few millimeters in size) from a distance of 25 meters or more. In certain embodiments, the camera 208 can be a Charge Coupled Device (CCD) camera. One example of a suitable CCD digital color camera is the ProMetric™ Light Measurement System, which is commercially available from the assignee of the present disclosure, Radiant Imaging, of Redmond, Wash. In other embodiments, the camera 208 can be a Complementary Metal Oxide Semiconductor (CMOS) camera, or another type of suitable camera for high-resolution long-distance imaging.

According to another aspect of the illustrated embodiment, the imaging device 106 can also include a lens 210. In one embodiment, for example, the lens 210 can be a reflecting telescope that is operably coupled to the camera 208 to provide sufficiently high resolution for long distance imaging of the sign 102. In other embodiments, however, the lens 210 can include other suitable configurations for viewing and/or capturing display information from the sign 102. A suitable imaging device 208 and lens 210 are disclosed in U.S. patent application Ser. No. 10/455,146, entitled “Method and Apparatus for On-Site Calibration of Visual Displays,” filed Jun. 4, 2003, and U.S. patent application Ser. No. 10/653,559, entitled “Method and Apparatus for On-Site Calibration of Visual Displays,” filed Sep. 2, 2003, each of which is incorporated herein by reference in its entirety.

The imaging device 106 can accordingly be positioned at a distance L from the sign 102. The distance L can vary depending on the size of the sign 102, and can include relatively large distances. In one embodiment, for example, the imaging device 106 can be positioned at a distance L that is generally similar to a typical viewing distance of the sign 102. In a sports stadium, for example, the imaging device 106 can be positioned in a seating area facing toward the sign 102. In other embodiments, however, the distance L can be less that a typical viewing distance and direction, and the imaging system 106 can be configured to account for any viewing distance and/or direction differences. Moreover, in other embodiments, the distance L can be between approximately 100 and 300 meters. In still further embodiments, the distance L can be approximately 200 meters. In yet other embodiments, the distance L can have other values.

The computing device 104 is configured to receive, manage, store, and/or process the display data collected by the imaging device 106 for the purpose of adjusting the appearance of images that will be displayed on the sign 102. In other embodiments, however, display data associated with the sign 102, including correction factors and related data, can be processed by a computer that is separate form the imaging device 106. A typical sign 102, such as an XGA-resolution visual display for example, can have over two million subpixels that provide display data for the computing device 104 to manage and process. As such, the computing device 104 includes the necessary hardware and corresponding software components for managing and processing the display data. More specifically, the computing device 104 configured in accordance with an embodiment of the disclosure can include a processor 220, a memory 222, input/output devices 224, one or more sensors 226 in addition to sensors of the imaging device 106, and/or any other suitable subsystems and/or components 228 (displays, speakers, communication modules, etc.). The memory 222 can be configured to store the display data from the sign 102. Moreover, the memory 222 can also be configured to include computer readable media including instructions or software stored thereon that, when executed by the processor 220 or computing device 104, cause the processor 220 or computing device 104 to process an image as described herein. Moreover, the processor 220 can be configured for performing or otherwise controlling calculations, analysis, and any other functions associated with the methods described herein.

In certain embodiments, the memory 222 can include software to control the imaging device 106 as well as measurement software to find portions of the sign 102 (e.g., subpixels of the sign 102) and image or otherwise extract the display data (e.g., brightness data, color data, etc.). One example of suitable software for controlling the imaging device 106 and/or acquiring the display data is the VisionCAL software, which is commercially available from the assignee of the present disclosure, Radiant Imaging, of Redmond, Wash. In other embodiments, other suitable software can be implemented with the system 100. Moreover, the memory 222 can also store one or more databases used to store the display data from the sign 102, as well as calculated correction factors for the display data. In one embodiment, for example, the database can be a Microsoft Access® database designed by the assignee of the present disclosure. In other embodiments, the display data can be stored in other types of databases or data files.

FIG. 3 is an enlarged partial front view of the imaging area 103 of the sign 102. The imaging area 103 is representative of a portion of the sign 102 (FIG. 1) and illustrates a display module 305. Each module 305 is made up of hundreds of individual light sources or light-emitting elements or pixels 330. Each pixel 330 comprises multiple light-emitting points or subpixels 332 (identified as first, second, and third subpixels 332a-332c, respectively). In certain embodiments, the subpixels 332 can be light-emitting diodes (“LEDs”). For example, the subpixels 332a-332c can correspond to red, green, and blue LEDs, respectively. In other embodiments, however, each pixel 330 can include more or less than three subpixels 332. For example, some pixels 330 may have four subpixels 332 (e.g., two green subpixels, one blue subpixel, and one red subpixel, or other combinations). Furthermore, in certain embodiments, the red, green, and blue (RGB) color space may not be used. Rather, a different color space can serve as the basis for processing and display of color images on the module 305. For example, the subpixels 332 may be cyan, magenta, and yellow, respectively. In addition to the color level of each subpixel 332, the luminance level of each subpixel 332 can vary. Accordingly, the additive primary colors represented by a red subpixel, a green subpixel, and a blue subpixel can be selectively combined to produce the colors within the color gamut defined by a color gamut triangle. For example, when only “pure” red is displayed, the green and blue subpixels may be turned on only slightly to achieve a specific chromaticity for the red color.

In addition to color and/or luminance, the subpixels 332 may have other visual properties that can be measured and analyzed in accordance with embodiments of the present disclosure. Moreover, although the imaging area 103 is described above with reference to pixels 330 and subpixels 332, other embodiments of the disclosure can be used with signs having different types of light emitting elements or components.

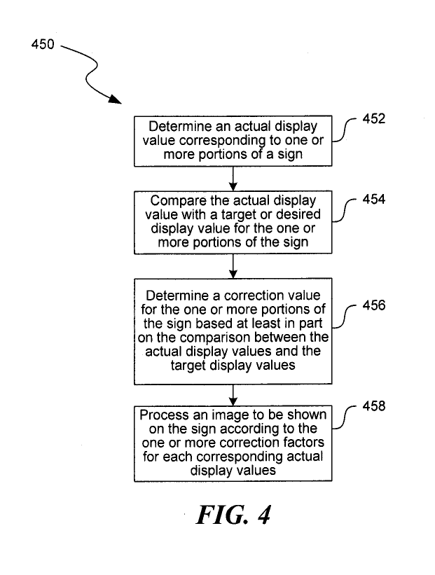

FIG. 4 is a flow diagram of a process or method 450 configured in accordance with an embodiment of the disclosure for processing an image (e.g., a still image, a video stream comprising a series of images, etc.) to be shown on the sign 102 described above with reference to FIGS. 1-3. The method 450 is configured to process adjust the appearance of an image such that the image can be shown on the sign 102 according to desired or target display parameters without calibrating or otherwise adjusting the display. Although the method 450 illustrated in FIG. 4 is at least partially described with reference to the system 100 of FIGS. 1-3, the method can be used with other types of systems 100 and/or displays 102 described above with reference to FIGS. 1-3.

The method 450 includes determining an actual display value corresponding to one or more portions of the sign (block 452). The determination of these actual display values are intended to refer to measurements or acquisitions of the actual display properties or characteristics of imaging areas of the sign. Referring to FIGS. 1 and 2, for example, the imaging device 106 can scan the sign 102 or capture an image of the sign 102 onsite without dismantling the sign 102 for further processing to determine the display values of the sign. Referring to FIG. 3 for example, the actual display values can include color data, luminance data, and/or other visual properties or characteristics of LEDs or individual subpixels 332 of the sign 102.

The actual display values may differ from desired or target display values of the sign. For example, there is typically significant variation in color or luminance of each sub-pixel of the display, especially if the sub-pixels are light emitting diodes (LEDs). Moreover, over time the visual properties of the sign 102 may degrade or otherwise vary from a desired or target display value. Accordingly, the method 450 illustrated in FIG. 4 further includes comparing the actual display value with a target or desired display value for the one or more portions of the sign (block 454). The method 450 further includes determining a correction value for the one or more portions of the sign (block 456). Determining the correction value for the corresponding portions of the display can include creating a correction data set or map including the correction value for the corresponding LEDs or sub pixels.

The determination of the correction values is based, at least in part, on the comparison between the actual display values and the target display values. More specifically, each correction factor can compensate for the difference between the actual display values and the corresponding target display value. For example, if the actual display value is less bright than the corresponding target display value, the correction factor can include the amount of brightness that would be required for the actual display value of the sign to be generally equal to the target display value. Moreover, the correction factor can correlate to the corresponding type of display value. For example, the correction value can be expressed in terms of color or brightness correction values, or in terms of other visual display property correction values. Suitable methods and systems for determining correction values or correction factors are disclosed in U.S. patent application Ser. Nos. 10/455,146 and 10/653,559 referenced above.

The method 450 further includes processing an image to be shown on the sign according to the correction factor for each corresponding actual display value (block 458). The image processing can be conducted independently from the calculation of the correction values (e.g., with a separate computer). Images processed according to the embodiments of the present disclosure can be in any type of file format including, for example, JPEG, TIFF, etc. Processing the image can include applying the data set of correction factors to the image so that the image will be shown on the display according to the target display values (e.g., color, luminance, etc.) without modifying or otherwise calibrating the corresponding actual display values of the subpixels, and/or without the sign itself applying any correction to the image to display the image according to the target values. More specifically, processing the image with the one or more correction factors can include applying the correction factor to one or more pixels of the image that will be displayed by the corresponding light emitting elements of the display. Processing the image in this manner can include applying the correction map to the image such that the appearance of the image will be displayed on the sign according to the target display values. As such, the image itself, rather than the sign, can contain the correction factor for each corresponding light emitting element of the sign (e.g., each subpixel of the sign) to account for the variation of actual display properties of the sign.

After processing the image, the method 450 can further include sending the image to the sign. The sign can therefore display the processed image according to desired or target display properties without calibrating or adjusting the display sign itself. In other embodiments, however, the correction factors or correction factor data set or map can be stored for processing different images to be shown on the sign. Moreover, the correction factor data set or map can be sent to a third party, such as the display owner, to enable the third party to process and display more than one image.

One advantage of the image processing system and associated methods described herein is that processing images in accordance with the present disclosure eliminates the need to calibrate or otherwise modify a display to achieve desired display properties. Many existing displays or signs do not have any built-in calibration equipment or hardware. Calibrating or otherwise adjusting the display properties of such signs typically requires additional hardware and/or replacement of some or all of the sign itself. In contrast, embodiments of the present disclosure alter the image sent to the sign rather than modifying the sign itself, and thereby eliminate the need to add calibration hardware to existing signs. In addition, embodiments of the present disclosure are also expected to be reliable and robust since these embodiments do not require the separate calibration hardware associated with the display sign. Furthermore, once a user obtains the correction factors for a particular display sign, the user can process an unlimited number of images or a video stream to be shown on the sign without requiring further calibration.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited, except as by the appended claims.

I/we claim:

1. A method of processing an image to be shown on a visual display sign, the method comprising:
determining an actual color value for one or more light emitting elements of the sign;
comparing the actual color value with a desired color value for the one or more light emitting elements;
determining a correction value for the one or more light emitting elements based on the comparison between the corresponding actual color values and the desired color values; and
processing an image to be shown on the sign with the correction value for the one or more light emitting elements so that the image is shown on the sign in the desired color value of the one or more light emitting elements.

2. The method of claim 1, further comprising transmitting the processed image to the sign to be shown on the sign in the desired color value.

3. The method of claim 1 wherein determining the actual value for the one or more light emitting elements comprises capturing the actual value with a camera spaced apart from the sign.

4. The method of claim 1 wherein determining the correction value for the one or more light emitting elements comprises determining at least one of a red correction value, a green correction value, and a blue correction value for each of the light emitting elements.

5. The method of claim 1 wherein:
determining the correction value for the one or more light emitting elements comprises creating a correction map including the correction value for the one or more light emitting elements; and
processing the image comprises applying the correction map to the image such that the image will be shown on the sign in the desired color value of the one or more light emitting elements without modifying the actual color value of the one or more light emitting elements.

6. The method of claim 1 wherein processing the image comprises applying the color value to one or more pixels of the image that correspond to the one or more light emitting elements.

7. The method of claim 1 wherein determining the actual color value for one or more light emitting elements comprises determining the actual color value for one or more light emitting diodes of the display.

8. The method of claim 1 wherein processing the image comprises processing a static image.

9. The method of claim 1 wherein processing the image comprises processing a video stream.

10. The method of claim 1 wherein processing the image so that the image is shown on the sign in the desired color value of the one or more light emitting elements comprises processing the image without modifying the actual color value of the one or more light emitting elements.

11. The method of claim 10 wherein processing the image without modifying the actual color value of the one or more light emitting elements comprises processing the image without modifying the actual color value of the one or more light emitting elements with any component of the sign.

12. The method of claim 1 wherein:
determining the correction value comprises determining nine correction values for corresponding individual light emitting elements; and
processing the image with the correction value comprises processing the image with the nine correction values for the corresponding individual light emitting elements.

13. The method of claim 1 wherein processing the image comprises processing the image at a separate stage before displaying the image on the sign.

14. A method of processing an image to be shown on a visual display, the method comprising:
receiving an actual display value corresponding to one or more portions of the display;
determining a correction factor for each corresponding actual display value, wherein the correction factor compensates for a difference between the actual display value and a target display value for the corresponding one or more portions of the display; and
processing the image according to the correction factor for each corresponding actual display value, wherein the processed image is configured to be shown on the display in the target display value for the one or more portions of the display without changing the actual display value of the one or more portions of the display.

15. The method of claim 14 wherein receiving an actual display value comprises receiving at least one of a brightness value and a color value of one or more imaging areas of the display.

16. The method of claim 14 wherein receiving an actual display value comprises receiving a display value of one or more corresponding light emitting elements of the display.

17. The method of claim 14, further comprising transmitting the processed image to the display.

18. The method of claim 17, further comprising showing the processed image on the display, wherein the image is processed separately from being shown on the display.

19. The method of claim 14 wherein processing the image comprises applying the correction factor to one or more portions of the image that will be displayed by the corresponding one or more portions of the display.

20. The method of claim 14 wherein:
receiving the actual display value comprises receiving the actual display value corresponding to one or more display pixels of the display; and
processing the image comprises applying the correction factor to one or more image pixels that will be displayed by the corresponding one or more display pixels.

21. The method of claim 14 wherein receiving the actual display value comprises sensing the actual display value with an imaging device that is remote from the display.

22. The method of claim 14 wherein processing the image comprises processing the image without modifying the actual display value of the one or more portions of the display with any component of the sign.

23. An apparatus for processing an image to be shown on a visual display, the apparatus comprising a computer-readable medium having instructions stored thereon that, when executed by a computing device, cause the computing device to perform steps comprising:
receiving a correction value for one or more portions of the display, wherein the correction value is based at least in part on a comparison between an actual display value for the one or more portions of the display and a target display value for the corresponding one or more portions of the display; and
adjusting one or more portions of the image with the correction value, wherein the adjusted one or more portions of the image are configured to be shown by the corresponding one or more portions of the display in the target display value without modifying the actual display value for the one or more portions of the display.

24. The apparatus of claim 23, wherein the computer-readable medium further comprises instructions to transmit the processed image to the display to show the processed image on the display, wherein the processed image is configured to be shown on the display in the target display value of the one or more portions of the display without modifying or calibrating the sign.

25. The apparatus of claim 23 wherein receiving the correction value comprises receiving the correction value of one or more light emitting elements of the display.

26. The apparatus of claim 23 wherein receiving the correction value comprises receiving a correction value that compensates for a difference between the actual display value and the target display value corresponding to the one or more portions of the display.
